(19) United States
(12) Patent Application Publication
(10) Pub. No.: US 2016/0314657 A1
(43) Pub. Date: Oct. 27, 2016

(54) PROGRESSIVE JACKPOT WITH CAPPING MECHANISM

(71) Applicant: Bally Gaming, Inc., Las Vegas, NV (US)

(72) Inventors: Dale R. Buchholz, Palatine, IL (US); Jacek Grabiec, Chicago, IL (US); James E. Oatman, Arlington Heights, IL (US); Gary J. Oswald, Elk Grove Village, IL (US); Douglas P. Reichmuth, Morton Grove, IL (US)

(21) Appl. No.: 15/130,423

(22) Filed: Apr. 15, 2016

Related U.S. Application Data
(60) Provisional application No. 62/152,131, filed on Apr. 24, 2015.

(51) Int. Cl. G07F 17/32

(52) U.S. Cl. CPC G07F 17/3258

(57) ABSTRACT

Capping single or multiple progressive wins subject to a maximum jurisdictional limit. Each progressive level(s) can be configured up to the maximum limit. The sum of all reset values for all levels does not exceed the maximum limit. The progressive award cannot exceed the maximum limit, and is funded first by the reset values of all progressive levels that triggered an award, followed by the increment values from the most rare to the least rare progressive levels up to the maximum limit. Any excess increment value is saved as short-term overflow and possibly long-term overflow. For the next play cycle, each progressive level is raised by its initial reset value plus its short-term overflow for that level, resulting in a higher reset value. Any increment that exceeds the maximum limit is stored as long-term overflow and is available to fund a subsequent play cycle following the next play cycle.

### CLAIM OF PRIORITY AND CROSS-REFERENCE TO RELATED APPLICATION

This application claims the benefit of priority to U.S. Provisional Patent Application No. 62/152,131, which was filed on Apr. 24, 2015, and is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, apparatus, and methods and, more particularly, to a casino wagering game associated with one or more progressive jackpots subject to a maximum jurisdictional limit.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Some wagering games include a progressive jackpot feature, and the progressive jackpot, in some legal jurisdictions, can be subject to a maximum limit or cap, which means that the player can be awarded no more than the maximum jurisdictional limit from the progressive jackpot during a play cycle of a wagering game (sometimes called a maximum win limit). A progressive feature could be designed so that the awarded progressives are small enough that the win limit can never be exceeded, even if the multiple progressives are awarded in the same play cycle and/or the same progressive is awarded more than once in the same play cycle. If multiple progressives are won and the total winnings must not exceed the win limit, it is conceivable to design the progressive such that in the worst case, when all the progressive levels are hit, the award will never exceed the win limit. However, such a game would be unattractive to play, particularly in jurisdictions with low maximum win limits, due to the small progressive awards. Thus, in jurisdictions with maximum win limits, a technical challenge is designing a wagering game system that optimizes (e.g., minimizes the impact to) the return-to-player (RTP) percentage and maximizes the progressive award amounts while ensuring compliance with the jurisdictional limits imposed on progressive jackpot awards. Aspects of the present disclosure solve these and other technical challenges for wagering games played in maximum win jurisdictions.

### SUMMARY OF THE INVENTION

According to an aspect of the present disclosure, a computer-implemented method of operating a gaming system is disclosed. The gaming system includes a random element generator, game-logic circuitry, and a gaming machine, the gaming machine primarily dedicated to playing at least one casino wagering game. The gaming machine includes a cabinet, an electronic display device, and an electronic input device. The cabinet is constructed to house components associated with the casino wagering game. The electronic display device and the electronic input device are coupled to the gaming cabinet. The method includes: generating one or more random elements with the random element generator; receiving, responsive to a physical input to the electronic input device of the gaming machine, a wager input to initiate a first play cycle of the casino wagering game; displaying one or more progressive jackpots on the electronic display device or on another electronic display device of the gaming system; determining, by the game-logic circuitry, an outcome of the casino wagering game based, at least in part, on the one or more random elements; displaying the outcome on the electronic display device of the gaming machine; responsive to a progressive triggering event occurring during the first play cycle, the progressive-triggering event resulting in a win award based on an amount in at least one of the one or more progressive jackpots, awarding, by the game-logic circuitry, no more of the win award than a maximum jurisdictional limit as a progressive award for the first play cycle; and responsive to the win award exceeding the maximum jurisdictional limit, saving, in an electronic memory device, a difference between the win award and the progressive award such that at least some of the difference is available to fund one or more subsequent play cycles following the first play cycle of the casino wagering game.

The at least one of the one or more progressive jackpots can be a strike progressive. The method can further include resetting, by the game-logic circuitry, a strike low boundary for the at least one of the one or more progressive jackpots to be based on at least a reset value for the at least one of the one or more progressive jackpots and the at least some of the difference to produce a new strike low boundary for the at least one of the one or more progressive jackpots.

The method can further include allocating, by the game-logic circuitry, a portion of an amount of the wager input to fund the at least one of the one or more progressive jackpots. The progressive triggering event can include the portion of the amount being added to the at least one of the one or more progressive jackpots, thereby causing the win award to exceed the maximum jurisdictional limit.

The progressive triggering event can be a displayed outcome in the casino wagering game. A portion of the amount of the wager input can be added to the at least one of the one or more progressive jackpots.

The at least one or more progressive jackpots can include a first progressive jackpot and a second progressive jackpot. The first progressive jackpot can be associated with a first strike value and a first strike low boundary. The second progressive jackpot can be associated with a second strike value and a second strike low boundary. The method can further include: calculating, by the game-logic circuitry, a sum that includes the first strike value and the second strike value. In response to the sum exceeding the maximum jurisdictional amount, the progressive award can include (1) the first strike low boundary, (2) the second strike low boundary, and (3) at least some of the remaining first strike value corresponding to a first increment value from the first progressive jackpot, wherein the first strike value has a hit rate that is less than that of the second strike value.

The difference can include a first difference and a second difference. The first difference can be based on at least (1) the first strike value, (2) a first portion of an amount of the wager input, (3) the first strike low boundary, and (4) the first increment value. The second difference can be based on at least (1) the second strike value, (2) a second portion of the amount of the wager input, and (3) the second strike low boundary. The method can further include storing the first difference and the second difference in separate locations in the electronic memory device as a first short-term overflow and a second short-term overflow.

The first short-term overflow and the second short-term overflow can be available to fund the immediately subsequent play cycle following completion of the first play cycle.

The method can further include: calculating, by the game-logic circuitry, a new first strike low boundary by calculating a first sum that includes (1) the first strike low boundary and (2) the first difference; setting, by the game-logic circuitry, the first strike low boundary for the first progressive jackpot to be the new first strike low boundary; calculating, by the game-logic circuitry, a new second strike low boundary by calculating a second sum that includes (1) the second strike low boundary and (2) the second difference; and setting, by the game-logic circuitry, the second strike low boundary for the second progressive jackpot to be the new second strike low boundary.

The first strike value can represent a minimum amount in the first progressive jackpot that must be funded to award at least part of the first progressive jackpot. The second strike value need not necessarily be identical to the first strike value and can represent a minimum amount in the second progressive jackpot that must be funded to award at least part of the second progressive jackpot. The first strike low boundary can represent a minimum of a range of possible strike values for triggering an award from the first progressive jackpot. The second strike low boundary can represent a minimum of a range of possible strike values for triggering an award from the second progressive jackpot.

The first strike value need not be displayed on the electronic video display as long as the first progressive jackpot is not exceeding the first strike value.

The method can further include raising a reset value for the at least one of the one or more progressive jackpots to include the at least some of the difference.

The method can further include, responsive to the difference exceeding the maximum jurisdictional limit, storing, in the electronic memory device, no more of the difference than the maximum jurisdictional limit as a short-term overflow and storing any excess between the difference and the maximum jurisdictional limit as a long-term overflow. The short-term overflow can be available to fund the immediately subsequent play cycle following the first play cycle. The long-term overflow can be available to fund a play cycle following the immediately subsequent play cycle.

The progressive award can be funded first up to a strike low boundary or a reset value associated with the at least one of the one or more progressive jackpots and then, if available, by increment values from the one or more progressive jackpots over the strike low boundary or the reset value up to a strike high boundary or the maximum jurisdictional limit. The increment values can be funded from wager inputs received by the casino wagering game.

The progressive triggering event can be associated with a strike progressive feature or a target progressive feature. The win award can be based on a portion of the wager input. At least some of the difference can fund at least one of the one or more progressive jackpots. The progressive award can be funded first from a reset value for the at least one of the one or more progressive jackpots and then from, if any, increment value remaining in the at least one of the one or more progressive jackpots up to the maximum jurisdictional limit. The progressive award can be funded first from the at least one of the one or more progressive jackpots having the highest value among all of the one or more progressive jackpots or having the most rare hit rate among all of the one or more progressive jackpots.

The one or more progressive jackpots can include a first progressive jackpot and a second progressive jackpot. A hit frequency of the first progressive jackpot can be less than a hit frequency of the second progressive jackpot. The increment value can be deducted first from the first progressive jackpot and then, if any, from the second progressive jackpot to fund the progressive award.

According to another aspect of the present disclosure, a gaming system includes: an electronic display device; an electronic memory device; a gaming machine primarily dedicated to playing at least one casino wagering game. The gaming machine includes a gaming cabinet and an electronic input device. The cabinet is constructed to house components associated with the casino wagering game. The electronic input device is coupled to the gaming cabinet and configured to receive a physical input from a player to initiate the casino wagering game and transform the input into an electronic data signal. The gaming system further includes a random element generator configured to generate one or more random elements. The game-logic circuitry is configured to: initiate a first play cycle of the casino wagering game in response to the electronic data signal from the electronic input device of the gaming machine, display one or more progressive jackpots on the electronic display device; determine an outcome of the casino wagering game based, at least in part, on the one or more random elements; direct the electronic display device or another electronic display device to display the outcome; and in response to a progressive triggering event occurring during the first play cycle, the progressive-triggering event resulting in a win award based on an amount in at least one of the one or more progressive jackpots, award no more of the win award than a maximum jurisdictional limit as a progressive award for the first play cycle; and in response to the win award exceeding the maximum jurisdictional limit, save, in the electronic memory device, a difference between the win award and the progressive award such that at least some of the difference is available to fund one or more subsequent play cycles following the first play cycle of the casino wagering game.

The progressive award can be funded first from a reset value for the at least one of the one or more progressive jackpots and then from, if any, increment value remaining in the at least one of the one or more progressive jackpots up to the maximum jurisdictional limit. The one or more progressive jackpots can include a first progressive jackpot and a second progressive jackpot. A hit frequency of the first progressive jackpot can be less than a hit frequency of the second progressive jackpot. The increment value can be deducted first from the first progressive jackpot.

Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is a flowchart of an example flowchart of a computer-implemented method for capping progressive jackpots or wins in a jurisdiction subject to a maximum win limit.

FIG. 5A is a functional block diagram of a target progressive feature having a single progressive jackpot pool in which a maximum wager input has been received on a primary or base casino wagering game.

FIG. 5B is a functional block diagram showing an award of the maximum limit with the excess in increment value from the jackpot being saved as short-term overflow.

FIG. 5C is a functional block diagram showing how the reset value for the progressive jackpot is raised for the next play cycle by the amount in the short-term overflow.

FIG. 5D is a functional block diagram showing receipt of a maximum wager in the next play cycle and how that wager funds the progressive jackpot and the casino wagering game.

FIG. 6A is a functional block diagram in which receipt a maximum wager in a casino wagering game triggers a win of two progressive jackpots, M1 and M2.

FIG. 6B is a functional block diagram showing how the progressive award is funded first by the reset values then by the increment values from M1, and the excess increment value from M1 and M2 is stored in the M1 and M2 short-term overflow, respectively.

FIG. 6C is a functional block diagram showing how the reset values for M1 and M2 are raised by the amount in the M1 and M2 short-term overflows, respectively.

FIG. 6D is a functional block diagram showing receipt of a maximum wager in a second play cycle and how the wager is used to fund M1 and M2 and the casino wagering game in the second play cycle.

FIG. 7A is a functional block diagram in which receipt of a maximum wager in a casino wagering game triggers a win of two progressive jackpots M1 and M2, but would result in a new reset value for M2 exceeding the maximum jurisdictional limit.

FIG. 7B is a functional block diagram showing how the progressive award is funded first by the reset values for MI and M2, and how the excess increment value for M1 is stored as M1 short-term overflow, and the excess increment value for M2 is divided between the M2 short-term overflow up to the maximum jurisdictional limit and M2 long-term overflow.

FIG. 7C is a functional block diagram showing how the new reset values for M1 and M2 are raised by the respective amounts in the M1 and M2 short-term overflow, with the long-term overflow for M2 remaining untouched.

FIG. 7D is a functional block diagram showing an automatic win generated following the first play cycle due to the M2 jackpot hitting the maximum limit, and how the progressive award is funded by the reset values for M1 and M2.

FIG. 7E is a functional block diagram following the second play cycle that shows the M2 long-term overflow being added to the M2 jackpot to fund the third play cycle.

FIG. 7F is a functional block diagram showing receipt of a maximum wager in the third play cycle and how this wager is divided to fund the M1 and M2 jackpots and the casino wagering game.

While the aspects of this disclosure are susceptible to various modifications and alternative forms, specific implementations and configurations have been shown by way of example in the drawings and will be described in detail herein. It should be understood, however, that the disclosed features are not intended to be limited to the particular forms disclosed. Rather, this disclosure covers all modifications, equivalents, and alternatives falling within the spirit and scope of the invention or inventions as defined by the appended claims.

### DETAILED DESCRIPTION

While this disclosure is susceptible of configuration and implementation in many different forms, there is shown in the drawings and will herein be described in detail examples of the inventions with the understanding that the present disclosure is to be considered as an exemplification of the principles of the inventions and is not intended to limit the broad aspect of the inventions to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

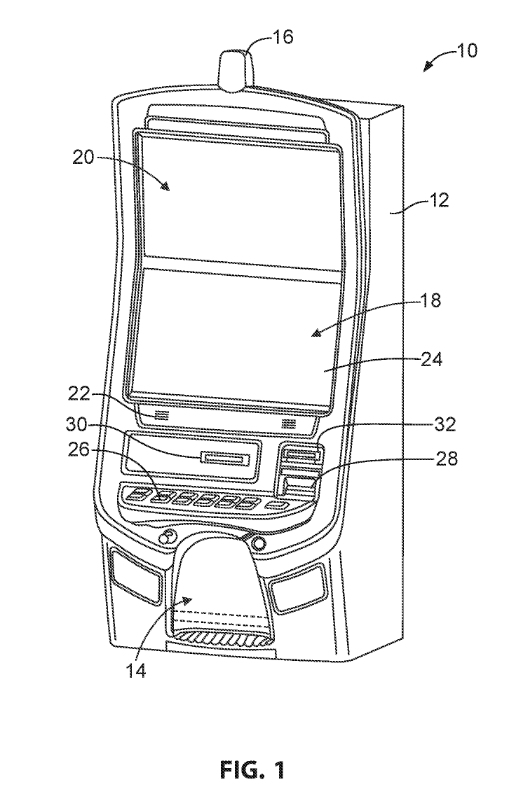

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6517433, 8057303, and 8226459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. The value input devices are used to deposit cash or credits onto the gaming machine 10. The cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. The value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

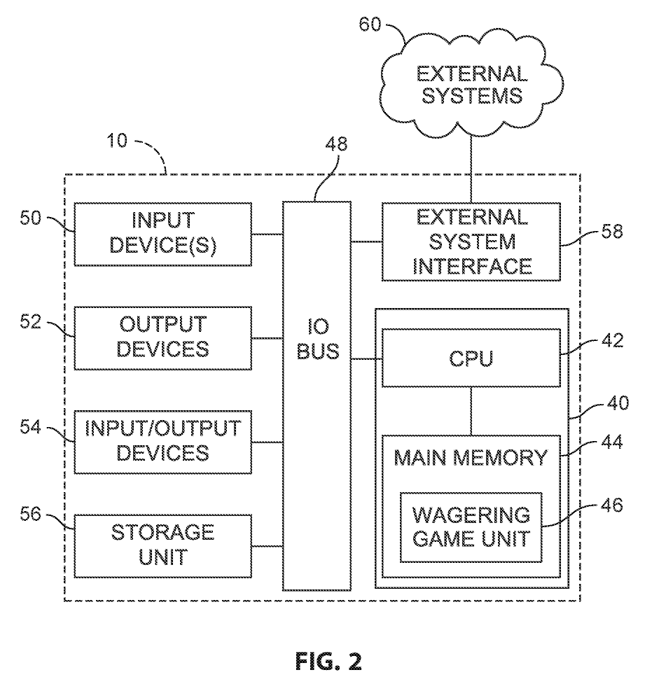

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

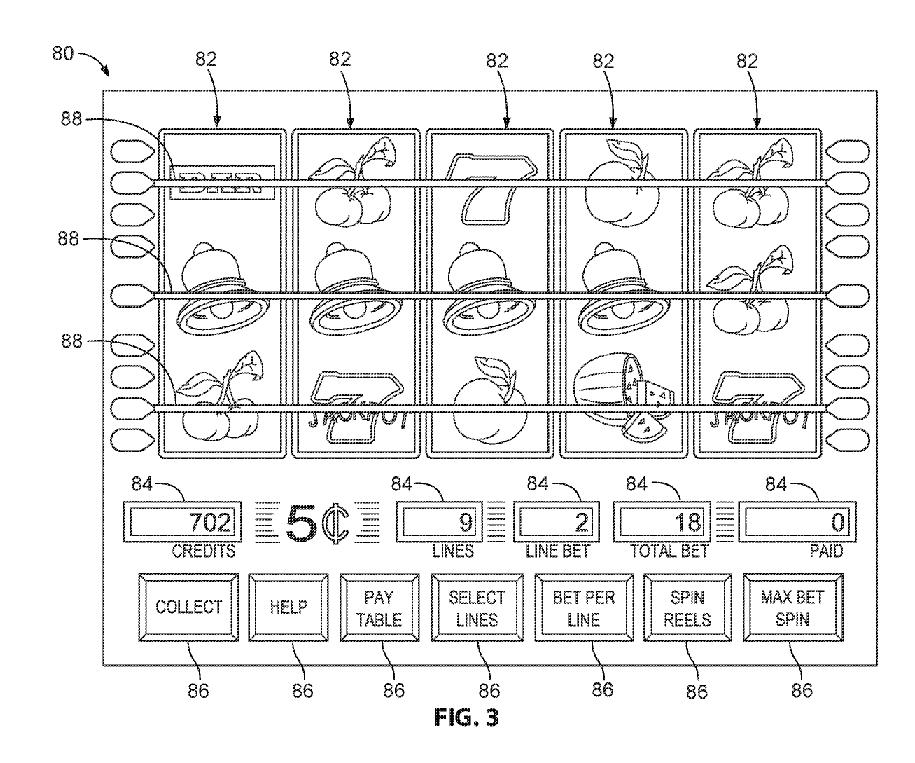

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

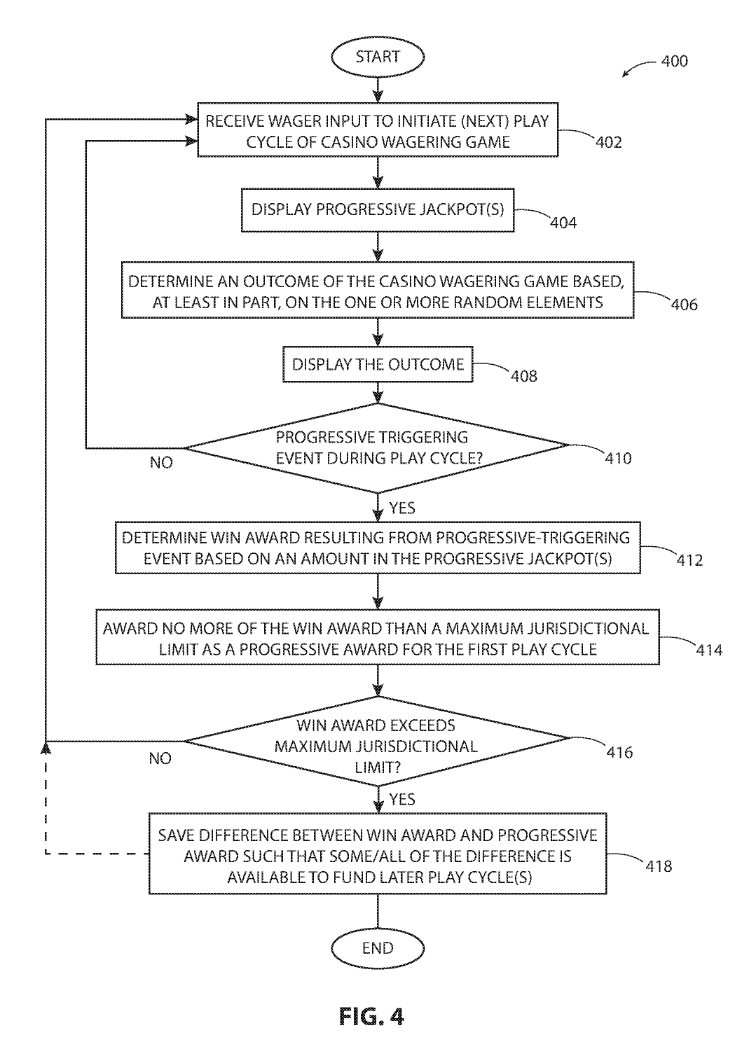

FIG. 4 is an example flow chart diagram of a computer-implemented method 400 of operating a gaming system, which can provide a casino wagering game with a progressive feature having at least one jackpot (or level) subject to a maximum win limit or cap imposed by a legal jurisdiction or regulatory authority. The term “progressive” as used herein has the ordinary meaning as understood by those skilled in the art of casino wagering games. Note that in some jurisdictions, such as Canada (e.g., the standards promulgated by the Western Canada Lottery Corporation or WCLC), a progressive can be called a bonus, but for ease of discussion and to avoid confusion with other types of bonus awards that can be awarded in connection with a casino wagering game, the term “progressive” will be used herein in accordance with its meaning familiar to those of ordinary skill in the United States in the art of casino wagering games. The method 400 describes a general approach to implementing an aspect of the present disclosure. Specific, albeit non-limiting and non-exhaustive examples to this general approach follow.

The gaming system that operates the method 400 can include a random element generator, game-logic circuitry 40, 60, which can include one or more electronic controllers or processors, and a gaming machine 10 or a computer device specially programmed with machine-readable instructions for carrying out the method 400. The gaming machine 10 is primarily dedicated to playing at least one casino wagering game, and includes a cabinet 12, one or more electronic display devices 18, 20, and one or more electronic input devices 24, 26. The cabinet 12 is constructed to house components associated with the casino wagering game. The electronic display device 18, 20 and the electronic input device 24, 26 are coupled to the gaming cabinet 12. The random element generator randomly generates elements, such as numbers, and can be implemented in electronic form. The gaming system can also include another electronic display device, which can be part of an external system 60 external to the gaming machine 10. This external electronic display device can display information relating to a progressive feature associated with a casino wagering game being conducted on the gaming machine 10 or a computer device. The computer device can be a portable electronic device, such as a smartphone or a computing tablet. For convenience, the reference number 10 shall refer herein to the gaming machine 10 described above in connection with FIGS. 1-3, or to any computer device such as a portable electronic device or a computer or computer system. Inputs made by a human player can be made using a touch screen, such as the touch screen 24, or any other human-machine interface device, such as a keyboard, a button, a mouse, a camera, a gesture sensing system, and the like. The reference numbers 18, 20 refer to herein to any video display on any device, such as on the gaming machine 10 or on a computing device or on an electronic display device external to the gaming machine 10 or the computing device and operably coupled therewith. The reference number 24 refers to herein to any touch screen on any device, such as on the gaming machine 10 or on a computer device.

The method 400 begins by generating one or more random elements with the random element generator and receiving, responsive to a physical input (such as made by a human player) to the electronic input device of the gaming machine 10 or computing device, a wager input to initiate a first play cycle of the casino wagering game (402). A play cycle begins with the receipt of a wager input on the casino wagering game and ends with the display of the outcome of the casino wagering game. The method 400 displays one or more progressive jackpots on the electronic display device or on another electronic display device of the gaming system (404). If more than one progressive jackpot is available, each jackpot can be on the same progressive level or on different progressive levels. As mentioned above, the progressive jackpots need not be displayed on the gaming machine 10 itself, but rather may be displayed on another electronic display device remote from and operably coupled to the gaming machine 10 or the computer device on which the casino wagering game is being portrayed. The progressive jackpot represents a dynamic tally updated in real-time of the amount of money available to be awarded if at least one criterion is satisfied.

The progressive jackpot may, for example, be awarded in a “strike” progressive game (also known as a “must-hit-by” progressive game) or a target progressive game (also known as a symbol-based progressive game). In a must-hit-by or “strike” progressive game, a strike value is randomly selected from a range defined by a strike low (or boundary) value and a strike high value. The strike low value can, though not necessarily, be equal to the reset value for the strike progressive. The strike high value can, though not necessarily, be set to equal the maximum jurisdictional limit. The randomly selected strike value is typically not displayed or known to the player. In a target or symbol-based progressive game, the occurrence of a special symbol or symbol combination displayed to the player as an outcome of the casino wagering game triggers a progressive award to be awarded in a target progressive. Once the special symbol or symbol combination occurs in a target progressive, the player that achieved that outcome in the casino wagering game is typically awarded whatever amount is in the progressive jackpot. However, a wrinkle addressed by the present disclosure is that this progressive win amount can be capped in some jurisdictions and is subject to a maximum win limit, so if the progressive jackpot(s) individually or collectively in a must-hit-by progressive or a target progressive exceed(s) the maximum win limit, the player cannot be awarded more than the maximum win limit.

The present disclosure addresses mechanisms for providing the maximum win award to the player and what to do with any extra value (e.g., credits) over and above the maximum win award still available to be awarded, extra value that is referred to herein as overflow. There are two types of overflow: short-term overflow, which is available to fund the immediately subsequent play cycle to the play cycle in which the maximum win award was made; and long-term overflow, which is available to fund a play cycle after the immediately subsequent play cycle. In other words, long-term overflow can be available to fund the third or fourth or fifth, etc. subsequent play cycle after the initial or first play cycle in which the maximum win award was made. The short-term overflow would fund the second play cycle. “Funding a play cycle” can include applying or adding the excess award value to one or more progressive jackpots (or levels) in one or more play cycles following the play cycle in which the excess value is generated.

Returning to the method 400, the game-logic circuitry 40, 60 determines an outcome of the casino wagering game based, at least in part, on the one or more random elements (406). The outcome is displayed on the electronic display device of the gaming machine or computing device (408). The method 400 determines whether a progressive triggering event occurred during the play cycle (410). If so, a win award is determined based on an amount in at least one of the one or more progressive jackpots (412). But, because a maximum jurisdictional limit is present, an award is awarded of no more of the win award than a maximum jurisdictional limit as a progressive award for the first play cycle (414). Numerous specific examples to this general approach will be discussed in more detail below. If a progressive triggering event does not occur during the play cycle, the method 400 continues from block 402. The progressive triggering event can be any event in the casino wagering game that triggers the player's eligibility to receive part or all of any one or more of the progressive jackpots. In a target progressive, for example, the progressive triggering event can be the presence of a special symbol or symbol combination in the outcome of the casino wagering game. In a strike progressive, for example, an award from one or more progressive jackpots is made when the jackpot reaches or “hits” a hidden strike value that is randomly selected between a strike low value and a strike high value.

As stated above, the total progressive award awarded to the player of the casino wagering game cannot exceed the maximum jurisdictional limit, so the method 400 determines whether the win award exceeds the maximum jurisdictional limit (416). Note that the win award represents the total award that the player would be awarded notwithstanding the maximum jurisdictional limit. By contrast, the progressive award is the amount that is actually awarded to the player. The win award is the same as the progressive award when the win award does not exceed the maximum jurisdictional limit. If the win award exceeds the maximum jurisdictional limit, the method 400 saves, in an electronic memory device 44, 56, 60, a difference between the win award and the progressive award such that at least some of the difference is available to fund one or more subsequent play cycles following the first play cycle of the casino wagering game (418). If the win award does not exceed the maximum jurisdictional limit, the progressive award equal to the win award is awarded to the player, and the method 400 returns to block 402. After saving the difference, the method 400 can return to block 402 to receive a wager for the next play cycle.

As noted above, a general approach is to save any excess award value that exceeds the maximum jurisdictional limit as an overflow to fund one or more subsequent play cycles. The overflow can be stored as a separate value or data structure in the electronic memory device 44, 56, 60. The next examples describe non-limiting and non-exhaustive ways of handling the overflow and how to fund the progressive jackpots following a progressive triggering event.

In discussing the examples below, the following terminology will be used:

| Term | Description |
|---|---|
| CURRENT VALUE: | current progressive (bonus) amount. |
| SHORT-TERM | amount exceeding limit added to the |
| OVERFLOW: | next play cycle. |
| WINS: | total value of wins for the progressive. |
| LIMIT: | bonus limit value. |
| MAXIMUM WIN LIM- | jurisdictional maximum win limit. |
| IT: MAXIMUM JURIS- | |
| DICTIONAL LIMIT: | |
| INCREMENT: | percentage increment rate. |
| INCREMENT VALUE: | amount per the increment rate. |
| RESET VALUE: | amount the progressive resets to after |
| | the progressive is won. |
| STRIKE VALUE: | winning value randomly set for Strike |
| | Progressive. |
| STRIKE LOW: | lower boundary of Strike Progressive. |
| STRIKE HIGH: | upper boundary of Strike Progressive. |
| LONG-TERM | amount exceeding limit carried forward |
| OVERFLOW: | beyond the next play cycle. |
| TARGET | symbol-based progressive won when a special |
| PROGRESSIVE: | symbol or symbol combination appears in the |
| | outcome of the casino wagering game. |
| STRIKE | progressive that is awarded only when |
| PROGRESSIVE: | jackpot hits a randomly selected strike |
| | value selected between a strike low |
| | value and a strike high value. |

A gaming machine 10 (or computer device configured to conduct wagering games thereon) can be configured to address all possible regulations. Thus, one set of machine-readable instructions for a casino wagering game can be created for all possible jurisdictions, and then a machine-readable register, for example, of the gaming machine 10 can be set as part of installation to configure the gaming machine to satisfy the requirements of the jurisdiction in which that gaming machine is installed. For example, just two bits can be used as a jurisdictional ID to configure Jackpot and Progressive Maximum Win Limits, such as two bits from the Serial Peripheral Interface (SPI) register. In addition, a memory allocation is made to specify the actual maximum jurisdictional limit in a given jurisdiction, e.g., storing the value of 1000 in the electronic memory device to represent a maximum limit of $1000.00 The different configurations can be set using two bits as set forth in the following example table:

| SPI Register | |
|---|---|
| Bit Value | Example Configuration |
| 00 | Base wagering game win and all progressive wins are a |
| | single cumulative value. |
| 01 | Two independent wins, one for base wagering game and |
| | one for the sum of all progressive levels. |
| 10 | Many Independent wins, one for the base wagering game |
| | and one for each progressive level. |

To prevent run-away long-term overflow, a game math configuration parameter can be configured to force the on-average progressive win(s) per play cycle to be a predetermined percentage less than the maximum win. Limiting the game math parameter prevents run-away overflow, and is particularly effective for target multi-level progressives where more than one level is more likely to be hit compared to strike multi-level progressives.

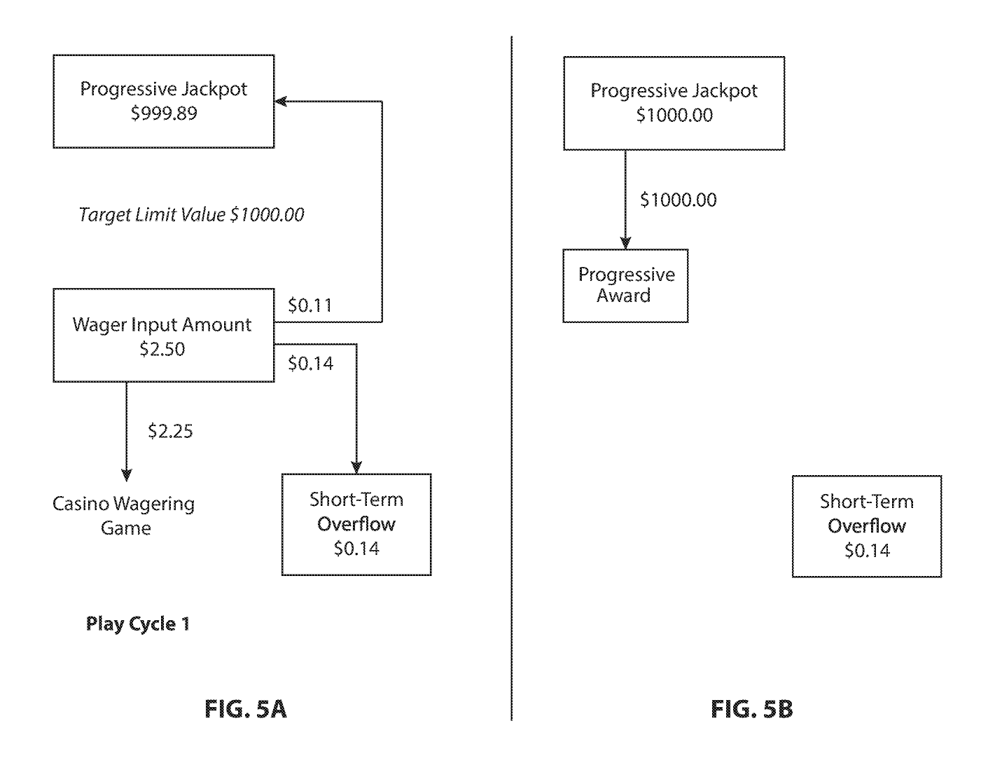

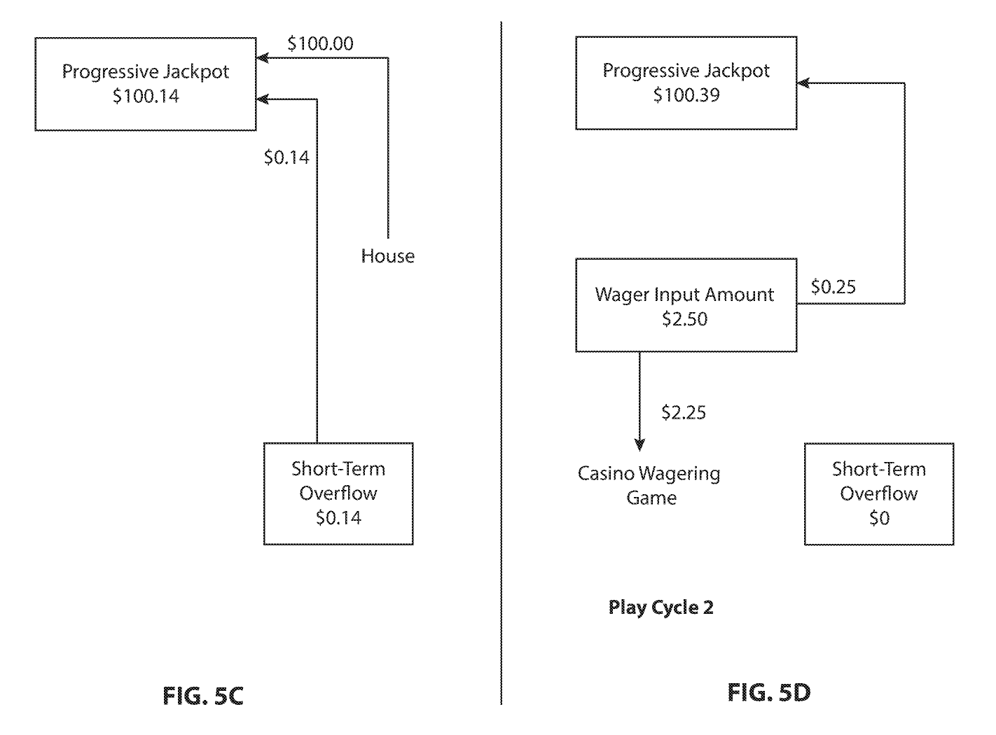

A first example will be described in connection with FIGS. 5A-5D and the tables set forth below. In this example, there is a single progressive jackpot pool, and the progressive feature is a target progressive. For example, when a special symbol combination appears in the outcome of the casino wagering game, the progressive jackpot is awarded to the player who is playing the casino wagering game that triggered the win. The special symbol combination needed to trigger an award of the target progressive jackpot is typically known by and displayed to the player. In FIG. 5A, a wager input amount of $2.50 has been received to play a first play cycle of a casino wagering game. In this example, the increment percentage used to fund the progressive jackpot is 10%, which means that of the $2.50 wager input amount, $0.25 will be used to fund the progressive jackpot, and the remaining $2.25 will be used to fund the casino wagering game. However, because the target value is $1000, the maximum jurisdictional limit in this example, only $0.11 of the wager input amount is added to the progressive jackpot so that a total of $1000 is awarded to the player. The remaining $0.14 that was diverted from the wager input amount to increment the progressive jackpot will be saved as a short-term overflow.

In FIG. 5B, the $1000 in the progressive jackpot is awarded to the player because the outcome in the casino wagering game corresponds to a special symbol combination that triggers an award of the target progressive jackpot. In a jurisdiction that does not have a maximum win limit, the player would have been awarded $1000.14, so the extra $0.14 in increment value is stored as short-term overflow to fund the next play cycle. In FIG. 5C, the progressive jackpot is reset to include a reset value of $100, which in this example is funded by the house (casino), and the $0.14 in increment value from the short-term overflow, for a total starting reset value of $100.14.

FIG. 5D illustrates the next play cycle immediately following the first play cycle. In this example, another wager input amount of $2.50 has been received, and 10% of that wager input amount is added to the progressive jackpot, bringing its total up to $100.39, while the remaining $2.25 is used to fund the casino wagering game. In this second play cycle, the short-term overflow is $0, having relinquished the $0.14 to fund the reset value in the progressive jackpot. The following tables illustrate the starting and new values in this example, and the calculations for each.

Target Progressive Feature - Single Progressive Jackpot Pool

| | |
|---|---|
| Limit: | $1000 |
| Maximum Wager: | $2.50 |
| Increment Percentage (10%): | $0.25 |
| Reset Value: | $100 |
| Current Value [of progressive jackpot]: | $999.89 |

Single Spin on Casino Wagering Game Wins on $2.50 Wager:

| | |
|---|---|
| Win Award ($999.89 + $0.25): | $1000.14 |
| Progressive Award = Maximum Win Limit: | $1000.00 |

Adjust Reset Value for the next play cycle and save Overflow:

| | |
|---|---|
| Short-term Overflow ($1000.14 − $1000.00): | $0.14 |
| New Reset Value for next play cycle ($100.00 + $0.14): | $100.14 |

In the above example, the limit of the target progressive is set to be equal to the maximum jurisdictional limit, but in other embodiments, the limit can be set to be lower than the maximum jurisdictional limit. Also, in the above example, when the target progressive was triggered, the current value was less than the maximum limit, but it is also conceivable that the current value of the target progressive jackpot can continue to accrue increment value without a winning special symbol combination appearing in the outcome of the casino wagering game. When this occurs, the current value that is displayed to the player can be frozen at the maximum jurisdictional limit (which in this example is $1000), while the excess increment that continues to accrue can be stored in the short-term overflow until a winning special symbol combination is achieved in a play cycle of the casino wagering game. When a winning special symbol combination appears in the outcome of the casino wagering game, the player is awarded the maximum jurisdictional limit amount of $1000, and the target progressive's reset value is adjusted to include the amount of accrued increment value in the short-term overflow.

A similar mechanism can be used for a strike progressive (as opposed to a target progressive described above) having a single progressive jackpot pool. A difference between a strike progressive versus a target progressive is that the strike value is typically not displayed to or known by the player. The player typically knows the strike high value, which is set to equal the maximum jurisdictional limit of $1000.00, but the actual strike value that triggers an award of the progressive jackpot is randomly selected by a random element generator between a range of values from a strike low to a strike high value for the progressive level. In this example, the strike value obscured from the player is $999.90, and the progressive jackpot currently stands at $999.89, one penny away from hitting the strike value (though the player does not know this). Thus, when the next $0.25 from the $2.50 wager is added to the progressive jackpot, it will exceed the strike value by $0.24. This $0.24 in excess increment value is saved as a short-term overflow, and the player is awarded the strike value of $999.90. The reset value or strike low value for the progressive jackpot is reset to equal the strike low or reset value, which here again is $100, plus the amount in the short-term overflow, for a total reset value of $100.24 to be available in the immediately following (subsequent or next) play cycle. In so doing, these two examples dynamically raise the strike low value (boundary) on the next play cycle to equal the reset value and the short-term overflow from the previous play cycle. Raising the reset value in this way prevents multiple same progressive pool wins on a single game play (i.e., re-trigger on same level progressives). The following tables illustrate how a new reset value can be adjusted based on residual increment value for the next play cycle in a jurisdiction subject to a maximum cap:

Strike Progressive Feature - Single Progressive Jackpot Pool

| | |
|---|---|
| Strike High Boundary (set to Limit): | $1000 |
| Maximum Wager: | $2.50 |
| Increment Percentage (10%): | $0.25 |
| Reset Value/Strike Low Boundary (set to Reset): | $100 |
| Strike Value: | $999.90 |
| Current Value: | $999.89 |

Single Spin in Casino Wagering Game Wins on $2.50 Wager:

| | |
|---|---|
| Award Progressive Strike Value: | $999.90 |

Adjust Reset Value for the next play cycle and save Overflow:

| | |
|---|---|
| Short-term Overflow/Increment Excess ($0.25 − $0.01): | $0.24 |
| New Strike Low Value for next play cycle ($100.00 + $0.24): | $100.24 |

In the above table, the strike low boundary value for the strike progressive is set to be equal to the reset value, but in other examples, the strike low boundary value in any strike progressive described herein can be set to be higher than the reset value. Also, the strike high boundary is set to be equal to the maximum jurisdictional limit in the above example, but in other examples, the strike high boundary in any strike progressive described herein can be set to be any value between the strike low boundary and the maximum jurisdictional limit.

Whereas the above two examples address a win in one play cycle of a single progressive jackpot pool, the next set of examples addresses multiple wins of more than one progressive jackpot pools (or pots) in the same play cycle. Broadly speaking, there are two ways multiple wins of two or more progressive jackpots can occur. In a first scenario, a player can trigger multiple progressive wins on the same level in the same play cycle. In a second scenario, the player can trigger multiple progressive wins on different levels in the same play cycle. The following table summarizes two different implementations that are equally applicable to strike or target progressives, with multiple progressive wins on the same or different levels:

| Example Implementation | | Alternate Implementation | |
|---|---|---|---|
| 1. | Award the reset values of all progressive | 1. | Award the highest value (or most rarely |
| | wins. | | hit) progressive win in full. |
| 2. | Award the progressive increment values of | 2. | Award the next highest value (or next most |
| | the progressive wins, from most-rare to | | rarely hit) progressive, up to the maximum |
| | least-rare, up to the maximum win. | | win. |
| 3. | Reset all progressives hit. | 3. | Reset all progressives hit. |
| 4. | Add short-term overflow to progressive | 4. | Add short-term overflow to progressive |
| | level(s) of the next play cycle. | | level(s) of the next play cycle. |

| a. | For Strike progressive, add to the | a. | For a Strike progressive, add to the |
|---|---|---|---|
| | strike-low boundary of the next | | strike-low boundary of the next |
| | play cycle. | | play cycle. |
| b. | For Target progressive, add to the | b. | For Target progressive, add to the |

| | |
|---|---|
| reset value of the next play cycle. | reset value of the next play cycle. |

| | | | |
|---|---|---|---|
| 5. | Save any long-term overflow amounts | 5. | Save any long-term overflow amounts |
| | larger than progressive limits for future | | larger than progressive limits for future |
| | progressive play cycle(s). | | progressive play cycle(s). |
| 6. | Gaming machine 10 reports to the | 6. | Gaming machine reports to the Progressive |
| | Progressive Controller AMOUNT-WON, | | Controller AMOUNT-WON, AMOUNT- |
| | AMOUNT-PAID, and the AMOUNT- | | PAID, and the AMOUNT-NOT-PAID to |
| | NOT-PAID to be applied to the next play | | be applied to the next play cycle. |
| | cycle. | | |

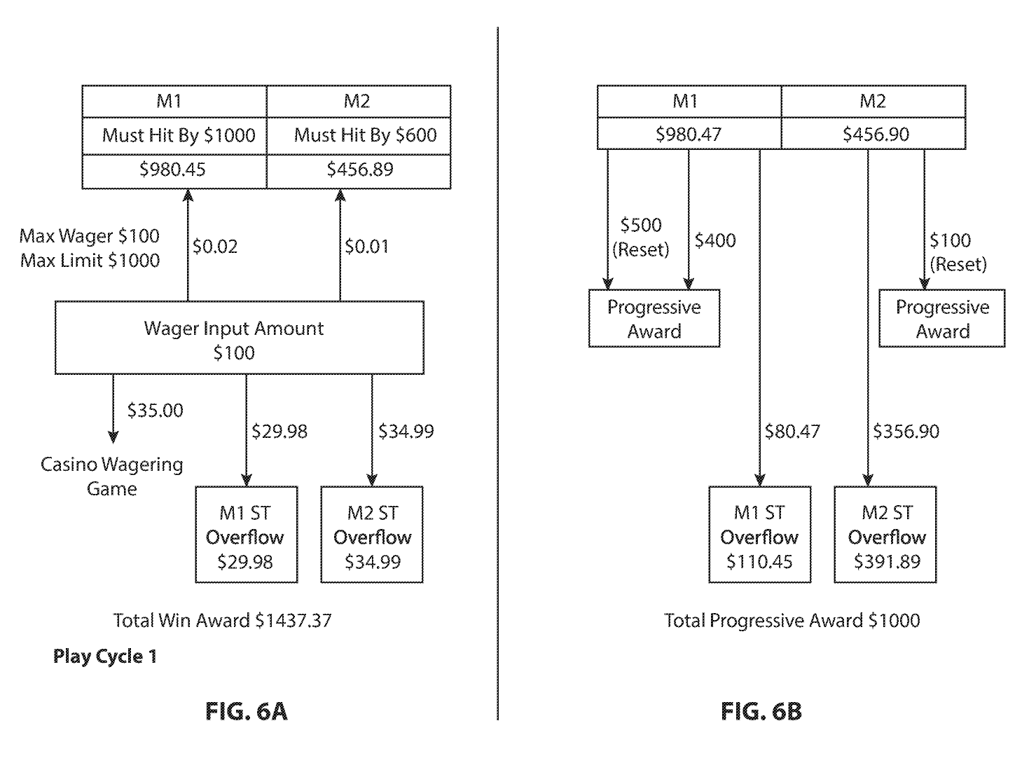

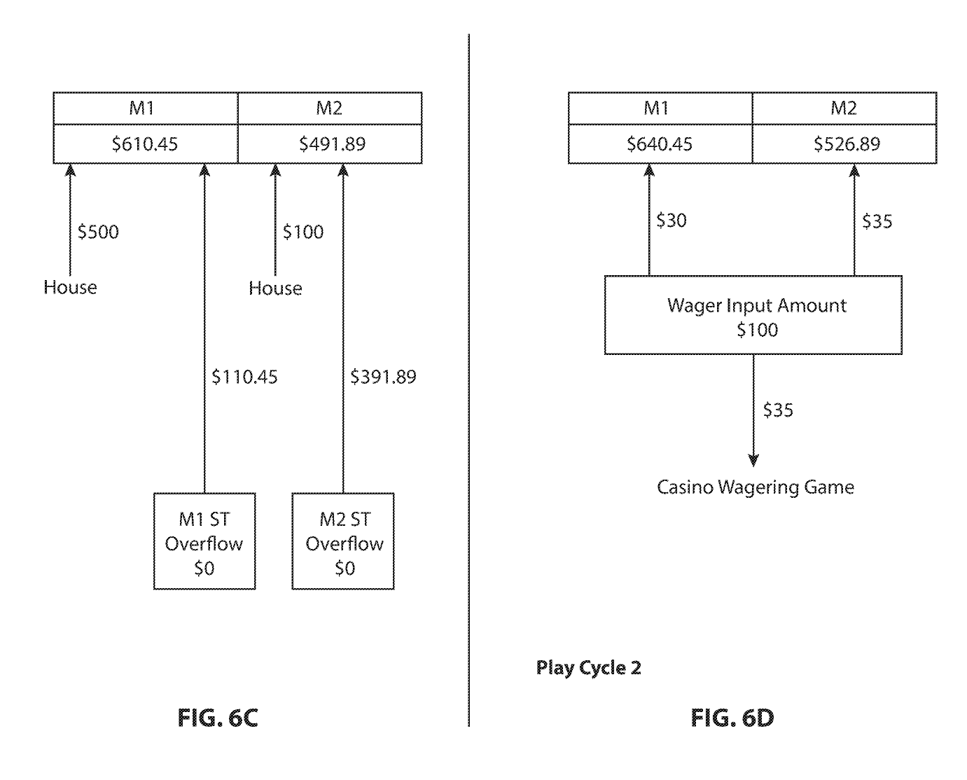

FIGS. 6A-6D will now be described with reference to the following table:

Two Strike Progressive Jackpots (M1, M2) - No Long-term Overflow

| | |
|---|---|
| Strike High Boundaries (set to Limit): | M1: $1000, M2: $600 |
| Maximum Wager: | $100 |
| Increment Percentages M1(30%), M2(35%): | M1: $30, M2: $35 |
| Reset Values/Strike Low Boundaries (set to Resets): | M1: $500, M2: $100 |
| Strike Values: | M1: $980.47, M2: $456.90 |
| Current Values: | M1: $980.45, M2: $456.89 |

Single Spin Wins both Bonus Pools on $100 Wager:

| | |
|---|---|
| Win Award of Strike Values M1($980.47) + | $1437.37 |
| M2($456.90): | |
| Award to Maximum Win Limit: | $1000.00 |
| Pay Reset Values M1($500) + M2($100) as Progressive | $600.00 |
| Award: | |
| Pay M1 Increment Values to Maximum Win Limit | $400.00 |
| ($1000 − $600) as Progressive Award: | |

Reset M1 & M2 for the next play cycle:

| | |
|---|---|
| Increment excess M1($30.00 − $0.02), M2($35.00 − $0.01): | M1: $29.98, M2: $34.99 |
| Short-Term Overflow M1($980.47 + $29.98 − $500 − | M1: $110.45, M2: $391.89 |
| $400), M2($456.90 + $34.99 − $100): | |
| New Strike Low Boundary M1($500.00 + $110.45), | M1: $610.45, M2: $491.89 |
| M2($100.00 + $391.89): | |

In FIG. 6A, there are two progressive jackpots, labeled M1 and M2 (e.g., Major 1 and Minor 2). The M1 jackpot has a strike low to strike high range between $500 and $1000, and the strike value has been randomly selected to be $980.47 and $456.90, respectively, for M1 and M2. The strike values are not known or displayed to the player of the casino wagering game. Thus, unbeknownst to the player of the casino wagering game, M1 is only two cents away from hitting the strike value, and M2 is only one penny away from hitting its strike value. In this example, a maximum wager amount of $100 has been received, and the casino wagering game produces a win for both M1 and M2 progressives. As shown in the table above, the increment percentage for M1 is 30%, and the increment percentage for M2 is 35%. Moreover, triggering M1 occurs more rarely (or less often) compared to triggering M2. Put another way, a hit of the strike value for M1 occurs more rarely or less frequently compared to a hit of the strike value for M2. Here, because the respective strike limits for M1 and M2 are almost reached, only two cents of increment value from the player's wager input amount is added to M1, and only one cent of increment value from the player's wager input amount is added to M2. However, because the increment percentage for M1 is 30%, $30 should have been used to fund the jackpot M1. Thus, $29.98 in increment value from the wager is saved in a short-term overflow for M1. Likewise, because the increment percentage for M2 is 35%, $35 should have been added to fund the jackpot M2. Thus, $34.99 in increment value from the wager is saved in a short-term overflow for M2. The remaining balance of the wager input amount, i.e., $35, is used to fund the casino wagering game on which the wager was placed.

In FIG. 6B, first, the amount corresponding to the reset value for M1 ($500) and the amount corresponding to the reset value for M2 ($100) is applied to fund the progressive award. Paying the reset values first in this example helps to optimize (e.g., minimize the impact to) the overall return-to-player (RTP) percentage for the game and minimize player liability. The progressive award now has $600, and the jurisdictional maximum limit is $1000 in this example, so another $400 has to be funded from another source. In this example, $400 of M1 increment values (funded from portions of the wager inputs or from another source) are used to fund the progressive award, to bring the total award to the maximum jurisdictional limit of $1000. Now, $80.47 of increment value remains in M1 and $356.90 of increment value remains in M2, and these amounts are added to the M1 and M2 short-term overflow, respectively. Again, the idea here is that the progressive award is funded first by the reset values for M1 and M2. If there is still more award to be funded, then the algorithm deducts from the increment values that have accrued in the most rarely occurring progressive jackpot pool, which in this example is designed to be M1. Note that the algorithm does not deduct yet from the M2 increment values, because a jackpot win for M2 occurs more frequently compared to M1. This ensures an optimal RTP by deducting award amounts first from the most rarely occurring progressive jackpot (e.g., the jackpot that is hit the least frequently). Indeed, in this example, no increment values from M2 are used to fund the progressive award, so the entire remaining balance in M2, here $356.90 is added to the M2 short-term overflow, bringing its total to $391.89.

In FIG. 6C, the reset values for M1 and M2 are reset as follows. The progressive jackpot for M1 is reset to the M1 reset value of $500, which can be contributed by the house, plus the amount of excess increment value saved in the M1 short-term overflow, which in this example is $110.45 from FIG. 6B. Likewise, the progressive jackpot for M2 is reset to the M2 reset value of $100, which can be contributed by the house, plus the amount of excess increment value saved in the M2 short-term overflow, which in this example is $391.89. The new reset value for the M1 progressive jackpot becomes $610.45 for the next play cycle, and the new reset value for the M2 progressive jackpot becomes $491.89 for the next play cycle. The strike value for at least M2 can be randomly reset to be a value between the new low strike value of $491.89 and the high strike boundary of $1000. For the sake of completeness, assume that the new strike value for M2 is randomly selected to be $678.45. Optionally, a new strike value for M1 can be randomly selected, or the original strike value of $980.47 can be retained because it is already above the new strike low value of $610.45.

In FIG. 6D, another maximum wager in the amount of $100 has been received. Per the increment percentages, $30 of this wager increments the M1 jackpot, bringing its new value to $640.45 after receipt of the $100 wager input, and $35 of the wager increments the M2 jackpot, bringing its new value to $526.89. The remaining $35 of the original $100 wager is used to fund the casino wagering game. Assuming that the strike value for M1 has not been reached yet, and the new strike value for M2 (e.g., $610.45) has not been reached yet, the M1 and M2 progressive jackpots are incremented by $30 and $35, respectively, and the remaining $35 from the $100 wager is used to fund the casino wagering game.

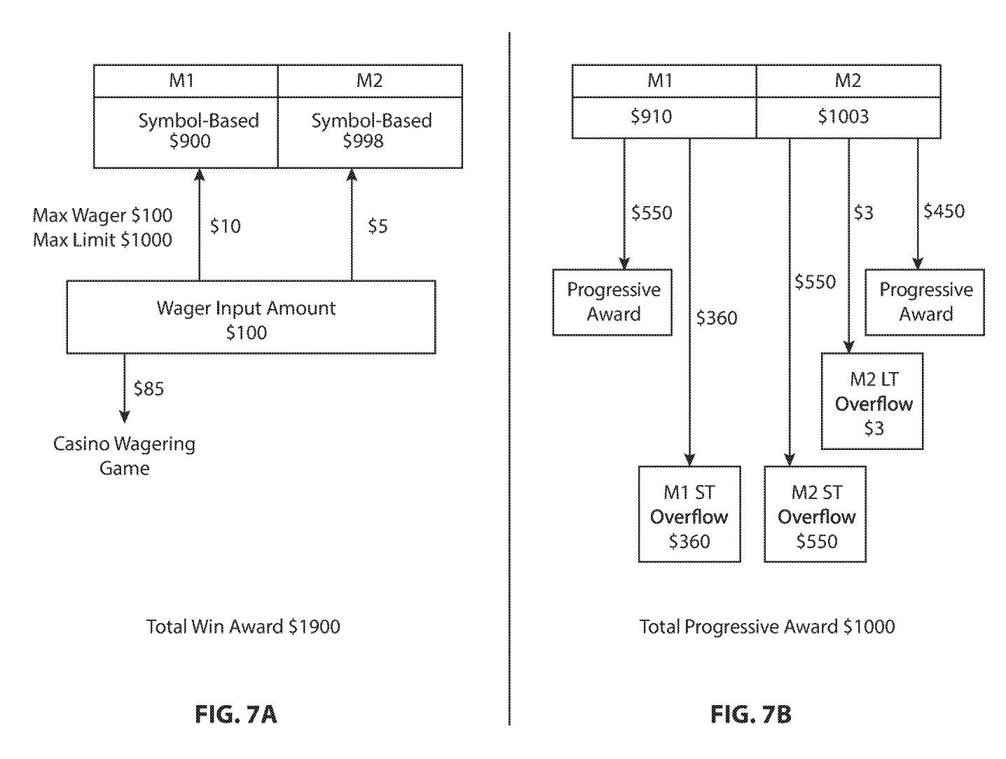

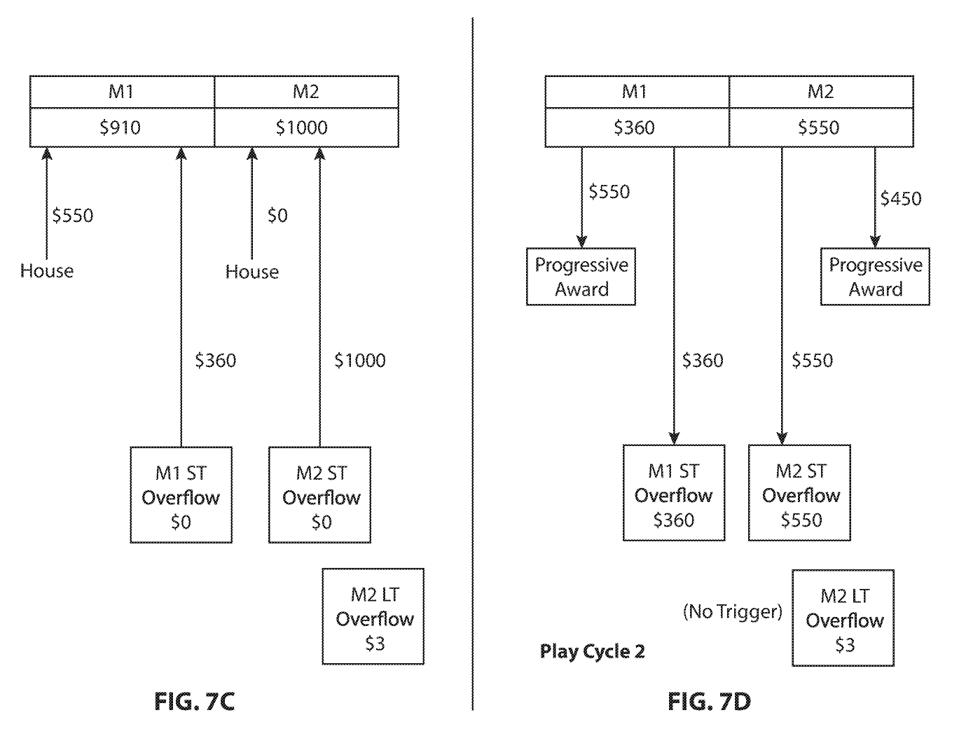

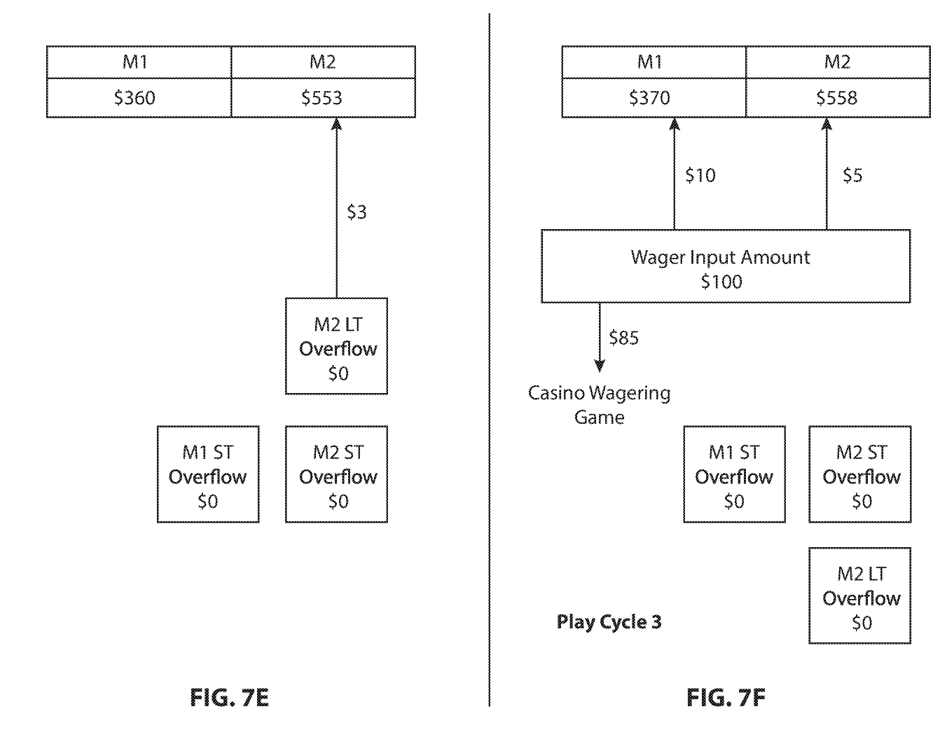

FIGS. 7A-7F will now be described with reference to the following table:

Two Strike Progressive Jackpots (M1, M2) With Long-Term Overflow

| | |
|---|---|
| Strike High Boundaries (set to Limit): | M1, M2: $1000 |
| Maximum Wager: | $100 |
| Increment Percentages M1 (10%), M2 (5%): | M1: $10, M2: $5 |
| Reset Values/Strike Low Boundaries (set to | M1: $550, M2: $450 |
| Resets): | |
| Strike Values: | M1: $901, M2: $999 |
| Current Values: | M1: $900, M2: $998 |

Single Spin Wins both progressive jackpot pools on $100 wager:

| | |
|---|---|
| Win Award of Strike Values M1 ($901) + M2 | $1900 |
| ($999): | |
| Progressive Award = Maximum Win Limit: | $1000 |
| Pay Reset Values M1 ($550) + M2 ($450): | $1000 |

Reset M1, M2 for the next play cycle:

| | |
|---|---|
| Increment excess M1 ($10 − $1), M2 ($5 − $1): | M1: $9, M2: $4 |
| Short-term Overflow M1 ($910 − $550), | M1: $360, M2: $550 |
| M2($1000 − $450): | |
| Long-term Overflow M2 ($553 + $450 − $1000): | M1: $0, M2: $3 |
| New Strike Low Boundary M1 (360 + 550): | M1: $910, M2: $1000 |

In FIG. 7A, there are two progressive jackpots, labeled M1 and M2 (e.g., Major 1 and Minor 2). The M1 jackpot has a known strike low to strike high range between $550 and $1000, and the M2 jackpot has a known strike low to high range between $450 and $1000. The strike value has been randomly selected to be $901 and $999, respectively, for M1 and M2. The strike values for M1 and M2 are not known or displayed to the player of the casino wagering game. Thus, unbeknownst to the player, M1 is only $1 away from hitting the strike value, and M2 is only $1 away from hitting its strike value. In this example, a maximum wager amount of $100 has been received, and the casino wagering game produces a win for both M1 and M2 progressives. As shown in the table above, the increment percentage for M1 is 10%, and the increment percentage for M2 is 5%. Moreover, triggering a win on M1 occurs more rarely (or less often) compared to triggering a win on M2. Here, because the respective strike limits for M1 and M2 are almost reached, only $1 of the player's $100 wager input amount needs to be added to M1 to hit M1's strike value of $901, and only $1 of the player's $100 wager input amount needs to be added to M2 to hit M2's strike value of $999. $85 of the initial $100 wager is used to fund the casino wagering game. In a jurisdiction that does not have a maximum limit, the total award would normally be the sum of both jackpots M1+M2, or $1900. However, because in this example there is a maximum jurisdictional limit of $1000, only $1000 can be awarded as the progressive award.

Thus, in FIG. 7B, the progressive award is funded first by the reset value for M1, the most rarely occurring progressive jackpot, which in this example amounts to $550. Then, the reset value for M2 is applied to fund the progressive jackpot, which in this example amounts to $450. Because the combined total of both reset values for M1 and M2 correspond exactly to the maximum jurisdictional limit, no increment values from either M1 or M2 need to be drawn from to fully fund the progressive award. The progressive award of $1000 is awarded, leaving a total of $913 in extra value ($900+$998+$15−$1000), which is stored as follows. The increment excess for M1 is $10−$1=$9, and the increment excess for M2 is $5−$1=$4. The short-term overflow for M1 is $901+$9−$550 (M1 reset value)=$360. The short-term overflow for M2 is $1000 (the other $3 from the increment excess is saved as long-term overflow, as discussed next)−$450 (M2 reset value)=$550. Normally, the total overflow for M2 would be $1003, but storing any value greater than $1000 in M2 short-term overflow would cause it to exceed the maximum jurisdictional limit of $1000. Thus, the remaining $3 is stored as long-term overflow for M2, as shown in FIG. 7B.

In FIG. 7C, the new reset or strike low value for M1 is funded by a contribution of the original reset value of $550 from the house, for example, or another source plus the amount in the M1 short-term overflow of $360, which results in a new reset value for M1=$910. In the case of M2, the house does not need to contribute any reset value because the M2 short-term overflow already contains $1000, the maximum jurisdictional limit. What this means is that play cycle 2 (immediately following play cycle 1) triggers an automatic win, regardless of the presence of a progressive-triggering event in the casino wagering game. Even if that outcome does not result in a progressive-triggering event, another progressive award of $1000 is awarded because M2's short-term overflow is already at the maximum jurisdictional limit. Thus, there is a 100% probability that M2 is guaranteed to hit on the next (second) play cycle. The $3 in the long-term overflow for M2 remains unchanged in the second play cycle.

In FIG. 7D, another progressive award of $1000 is awarded in the second play cycle, and is funded by $550 from M1 (its reset value)+$450 from M2 (its reset value), resulting in $360 in excess to be saved in the M1 short-term overflow and $550 to be saved in the M2 short-term overflow.

As can be seen in FIG. 7E, because neither M1 nor M2 exceed their respective strike values of $901 and $999, the $3 from M2's long-term overflow is now added into M2, to bring its reset value to $553. Now, in FIG. 7F, when the play cycle 3 is initiated by receipt of a wager input amount of $100, M1 is incremented by $10, M2 is incremented by $5, and all short- and long-term overflows for M1 and M2 are zeroed out.

Two additional examples will be discussed next in connection with the tables below for a casino wagering game having a target progressive feature, one with no long-term overflow and one with long-term overflow, and both having two progressive jackpots, M1 and M2.

Target Progressive with Two Jackpots - No Long-term Overflow

| | |
|---|---|
| Limit: | M1: $1000, M2: $600 |
| Maximum Wager: | $100 |
| Increment Percentages M1 (30%), M2 (35%): | M1: $30, M2: $35 |
| Reset Values: | M1: $500, M2: $100 |
| Current Values: | M1: $980.45, M2: $456.89 |

Single Spin on Casino Wagering Game Wins Both
Progressive Jackpot Pools on $100 Wager:

| | |
|---|---|
| Win Award = M1 ($980.45 + $30.00) + M2 | M1: $1010.45, M2: $491.89 |
| ($456.89 + $35.00): | ($1,502.34 > $1000 max limit) |
| Progressive Award = Maximum Win Limit: | $1000.00 |
| Pay Reset Values M1($500) + M2($100): | $600 |
| Pay M1 Increment Values to Maximum Win Limit | $400.00 |
| ($1000 − $600): | |

Reset M1 & M2 for the next play cycle:

| | |
|---|---|
| Short-term Overflow M1 ($980.45 + $30 − $500 − $400), | M1: $110.45, M2: $391.89 |
| M2 ($456.89 + $35 − $100): | |
| New Reset Values M1($500.00 + $110.45), | M1: $610.45, M2: $491.89 |
| M2($100.00 + $391.89): | |

In the above example, the M1 jackpot occurs less often compared to the M2 jackpot, and the progressive award is funded first by the reset values for M1 and M2, followed by the increment values from M1 until the jurisdictional maximum limit is reached. No increment values from M2 are needed to fully fund the progressive award up to the jurisdictional maximum limit. The short-term overflow for M1 and M2 is combined with the previous reset values ($500, $100) for M1 and M2 to produce new reset values for M1 ($610.45) and M2 ($491.89). These are the new reset values used for the next play cycle, which means that less increment value will be needed to achieve the limit of $1000 for M1 and $600 for M2. As mentioned above, if the increment value accruing in M1 or M2 exceeds the limit for M1 or M2, respectively, without a winning special symbol combination appearing in the outcome of the casino wagering game, the excess increment value over the maximum limit can be stored in the short-term overflow for M1 or M2 as the case may be. When the target progressive is triggered by a winning progressive outcome in the casino wagering game, the player is awarded $1000, and the reset value for M1 or M2 is adjusted to include the accrued excess increment value stored in the corresponding short-term overflow.

In the following example, the overflow of M2 after the progressive award has been awarded in the first play cycle would cause M2's reset value to exceed the maximum jurisdictional limit, so the excess for M2's new reset value above the maximum jurisdictional limit is saved as long-term overflow for use in a future play cycle after the second play cycle.

Target Progressive with Two Jackpots and Long-term Overflow

| | |
|---|---|
| Limit: | M1,M2: $1000 |
| Maximum Wager: | $100 |
| Increment Percentages M1(10%), M2(5%): | M1: $10, M2: $5 |
| Reset Values: | M1: $550, M2: $450 |
| Current Values: | M1: $900, M2: $998 |

Single Spin on Casino Wagering Game Wins Both
Progressive Jackpot Pools on $100 Wager:

| | |
|---|---|
| Win Award = M1($900 + $10) + M2($998 + $5): | M1: $910, M2: 1003 (Total $1913) |
| Progressive Award Capped at Maximum Win Limit: | $1000 |
| Pay Reset Values M1($550) + M2($450) first: | $1000 |

Reset M1, M2 for the next play cycle:

| | |
|---|---|
| Short-term Overflow M1($900 + $10 − $550), M2($1000 − | M1: $360, M2: $550 |
| $450): | |
| Long-term Overflow M2 ($553 + $450 − $1000): | M1: $0, M2: $3 |
| New Reset Values M1 ($360 + $550), M2 ($1000): | M1: $910, M2: $1000 |

In the above table, it can be seen that the new reset value for M2 exceeds $1000 by $3. The new reset value for M2 becomes $1000, which triggers an automatic win of the progressive in the next play cycle, and the additional $3 is stored as long-term overflow for use in the third play cycle or beyond. Again, like the previous examples, the occurrence of the M1 jackpot is more rare compared to that of the M2 jackpot, so the progressive award is funded first from the reset values for M1 and M2, and then from the increment values for M1 before increment values, if any, are drawn from M2. The long-term overflow ensure that no new reset value after a play cycle will ever exceed the maximum jurisdictional limit, thereby ensuring compliance in these jurisdictions with the maximum limits. In other words, the sum of all reset values is always less than or equal to the maximum jurisdictional limit.

Each level in the progressive feature, whether on the same level or on multiple levels, can be configured to have a strike value (in the case of a strike progressive) or a target limit (in the case of a target progressive) up to the maximum jurisdictional limit without violating the jurisdictional rules on maximum award limits. At least some of the approaches described herein realize an optimal way to achieve the math objectives for the progressive features by paying the reset values first of all wins, which minimizes the impact on RTP that is based on the reset values. Alternately or additionally, paying the increment values from the most rare pool to the least rare pool ensures that the awards are awarded to the player as quickly as possible. For each progressive jackpot, the reset value (which in a strike progressive corresponds to the strike low boundary) on the next play cycle is raised based on the short-term overflow available for each jackpot. If the adjusted reset value (or upper strike boundary value) would exceed the maximum jurisdictional limit, then any amount over the limit is stored as long-term overflow for use in play cycles beyond the next play cycle. By dynamically raising the reset value or strike low boundary on the next play cycle to be based on at least the short-term overflow and optionally the previous reset value, multiple same progressive jackpot wins are prevented on a single play cycle (e.g., re-trigger). These approaches are particularly advantageous for multiple wins in the same play cycle of multiple same-level or multiple level progressive jackpots, although the principles described herein apply equally to single wins, such as shown and described in connection with FIGS. 5A-5D.

The above progressive examples fund the progressive award from the reset values first, then from any increment value, starting with the most-rarely hit jackpot to the least-rarely hit jackpot. In another implementation, as summarized in the “Alternate Implementation” in the table above, instead of funding the progressive award from the reset values first, the progressive award can be funded first from the highest progressive jackpot to, if applicable, the next highest progressive jackpot, and so on, independent of the reset values. Some reset value may end up in the progressive award, but in this alternate implementation, the algorithm ranks each progressive award value, and begins funding the progressive award starting with the highest jackpot value. The next few tables illustrate different examples for target and strike progressives, with single levels and multiple levels.

This first example of the alternate implementation is a strike progressive having two progressive jackpot pools. While this example is similar to the example shown above, the algorithm funds the progressive award starting from the highest jackpot without evaluating whether any of that award includes any reset values. It may be the case that the award does include at least some reset value, but the difference here is that the algorithm effectively “ignores” whether any reset value is being used to fund the progressive award, and instead simply looks to fund the progressive award starting with the highest jackpot. Again, the difference here is that in the implementations described above, the progressive award is first funded from all of the reset values before tapping into any of the increment value. However, in the examples provided below just like in the example above, the new strike low or reset values are still adjusted in the next play cycle to include the leftover overflow from the previous play cycle in which the progressive win occurred.

Two Strike Progressive Jackpots (M1, M2) - No Long-term Overflow

| | |
|---|---|
| Strike High Boundaries (set to Max Win): | M1: $1000, M2: $600 |
| Maximum Wager: | $100 |
| Increment Percentages M1(30%), M2(35%): | M1: $30, M2: $35 |
| Reset Values/Strike Low Boundaries (set to Resets): | M1: $500, M2: $100 |
| Strike Values: | M1: $980.47, M2: $456.90 |
| Current Values: | M1: $980.45, M2: $456.89 |

Single Spin on Casino Wagering Game Wins
both M1 and M2 Jackpots on $100 Wager:

| | |
|---|---|
| Win Award of Strike Values M1($980.47) + | $1437.37 |
| M2($456.90): | |
| Progressive Award = Strike Values up to Maximum Win | $1000.00 |
| Limit: | |
| Fund Progressive Award first from highest jackpot | M1: $980.47, M2: $19.53 |
| M1($980.47) then from next highest jackpot M2($1000 − | |
| $980.47) up to $1000 maximum limit: | |

Reset M1 & M2 for the next play cycle:

| | |
|---|---|
| Contribution of M1, M2 increment excess to overflow | M1: $29.98, M2: $34.99 |
| M1($30.00 − $0.02), M2($35.00 − $0.01): | |
| Short-Term Overflow M1($29.98), M2($456.90 − | M1: $29.98, M2: $472.36 |
| $19.53 + $34.99): | |
| New Strike Low Boundary M1($500.00 + $29.98), | M1: $529.98, M2: $572.36 |
| M2($100.00 + $472.36): | |

In the next example table, a target progressive has two jackpots, and a special symbol or symbol combination appears in the outcome of the casino wagering game, triggering a win of both jackpots. Again, as in the table immediately above, the progressive awarded is funded based on the quantity of the amount in each of the jackpots, regardless of the reset values, in the order of highest quantity to lowest quantity.

Target Progressive with Two Jackpots - No Long-term Overflow

| | |
|---|---|
| Max Win: | M1: $1000, M2: $600 |
| Maximum Wager: | $100 |
| Increment Percentages or Contributions M1 (30%), M2 | M1: $30, M2: $35 |
| (35%): | |
| Reset Values: | M1: $500, M2: $100 |
| Current Values as shown in the progressive jackpot | M1: $980.45, M2: $456.89 |
| meters: | |

Single Spin on Casino Wagering Game Wins Both
Progressive Jackpot Pools on $100 Max Wager:

| | |
|---|---|
| Win Award = M1 ($980.45 + $30.00) + M2 | M1: $1010.45, M2: $491.89 (M1 + |
| ($456.89 + $35.00): | M2 = $1,502.34 > $1000 max limit) |
| Progressive Award funded first from M1 ($1000), | $1000.00 |
| without drawing from M2's reset or increment values | |

Reset M1 & M2 for the next play cycle:

| | |
|---|---|
| Short-term Overflow M1 ($1010.45 − $1000), M2 | M1: $10.45, M2: $491.89 |
| ($456.89 + $35): | |
| New Reset Values M1($500.00 + $10.45), | M1: $510.45, M2: $591.89 |
| M2($100.00 + $491.89): | |

The above multi-level progressive examples assume two progressive jackpots, but in other implementations, more than two progressive jackpots could conceivably be hit during the same play cycle. The next two examples show a progressive award capping mechanism when up to four progressive jackpots are hit in the same game cycle. Again, instead of funding the progressive award from the reset values, the algorithm funds the progressive award by drawing first from the highest progressive jackpot, and then from the next highest, and so forth, until the maximum jurisdictional limit is reached.

Strike Progressive with Four Jackpots and Short- and Long-term Overflow

| Strike High Boundaries (Set to Max Win): | M1, M2, M3, M4: $1000 |
|---|---|
| Maximum Wager: | $100 |
| Increment Percentages (Contributions) M1(10%), | M1: $10, M2: $5, M3: $2, M4: $1 |
| M2(5%), M3(2%), M4(1%): | |
| Reset Values/Strike Low Boundaries (set to Reset | M1: $450, M2: $350, M3: $150, M4: |
| Values): | $50 |
| Strike Values: | M1: $901, M2: $999, M3: $951, M4: |
| | $926 |
| Current Values (Meters): | M1: $900, M2: $998, M3: $950, M4: |
| | $925 |

Single Spin on Casino Wagering Game Wins All
Four Progressive Jackpot Pools on $100 Max Wager:

| | |
|---|---|
| Win Award based on Strike Values = M1($901) + | $3777 >> Max Limit |
| M2($999) + M3($951) + M4($926): | |
| Pay from highest jackpot M2($999) and then next | M2: $999, M1: $1 |
| highest jackpot independent of reset values M1($1000 − | |
| $999) to Max Win to fund Progressive Award: | |
| Progressive Award: | $1000 |

Reset M1, M2, M3, and M4 for the next play cycle:

| | |
|---|---|
| Contribution to Short-term Overflow (may include | M1: $9, M2: $4, M3: $1, M4: $0 |
| some reset value or some increment value or | |
| combination of both) M1($10 − $1), M2($5 − $1), M3($2 − | |
| $1), M4($1 − $1): | |
| Short-term Overflow M1($901 − $1 + $9), M2($4), | M1: $909, M2: $4, M3: $952, M4: |
| M3($951 + $1), M4($926 + $0): | $926 |
| Long-term Overflow M1($909 + $450 − $1000), M3 | M1: $359, M2: $0, M3: $102, M4: $0 |
| ($952 + $150 − $1000): | |
| New Strike Low Values M1 ($350 + $4), M2 | M1: $1000, M2: $354, M3: $1000, |
| ($926 + $50): | M4: $976 |

In this final example table, a target progressive is presented with four progressive jackpot pools, and the progressive award is funded from the highest jackpot to the next highest, and so forth. The excess value above the maximum jurisdictional limit, whether comprised of reset value or increment value or some combination of both, is stored in short-term overflow. In this example below, some of the jackpots have enough value to exceed the maximum jurisdictional limit, so some of that value is stored in long-term overflow, as shown in the following table.

Target Progressive with Four Jackpots and Short- and Long-term Overflow

| Strike High Boundaries (Set to Max Win): | M1, M2, M3, M4: $1000 |
|---|---|
| Maximum Wager: | $100 |
| Increment Percentages (Contributions) M1(10%), | M1: $10, M2: $5, M3: $2, M4: $1 |
| M2(5%), M3(2%), M4(1%): | |
| Reset Values/Strike Low Boundaries (set to Reset | M1: $450, M2: $350, M3: $150, M4: |
| Values): | $50 |
| Current Values (Meters): | M1: $900, M2: $998, M3: $950, M4: |
| | $925 |

Single Spin on Casino Wagering Game Wins All
Four Progressive Jackpot Pools on $100 Max Wager:

| | |
|---|---|
| Win Award = M1($900 + $10) + M2($998 + $5) + | M1: $910, M2: $1003 (highest), M3: |
| M3($950 + $2) + M4($$925 + $1): | $952, M4: $926 |
| Progressive Award Funded from M2 (highest) up to | $1000 (taken from M2 only) |
| maximum limit: | |

Reset M1, M2, M3, and M4 for the next play cycle:

| | |
|---|---|
| Short-term Overflow M1($910), M2($1003 − $1000), | M1: $910, M2: $3, M3: $952, M4: |
| M3($952), M4($926): | $926 |
| Long-term Overflow M1($910 + $450 − $1000), M3 | M1: $360, M2: $0, M3: $102, M4: $0 |
| ($952 + $150 − $1000): | |
| New Reset Values: M2 ($350 + $3), M4 ($50 + $926): | M1: $1000, M2: $353, M3: $1000, |
| | M4: $976 |

In still another implementation, instead of funding the progressive award from the highest jackpot, it can be funded from the most-rare jackpot first, which may happen to also be the highest jackpot, though not necessarily so. Thus, in the table above involving a strike progressive and four jackpot pools, if M1 were the most rarely hit jackpot (e.g., having the lowest hit rate among M1-M4), the progressive award could be funded entirely from M1 first ($910), and then another $10 taken from M2 next (M2 being the next most rarely hit jackpot). Funding the progressive award using the most rare money or from the highest jackpot (these two can be the same) ensures that the player receives the most rare money first, which means that the game converges to the correct mathematical parameters as quickly as possible. The RTP and accounting calculations are slightly more complex compared to an implementation where the progressive award is first funded by the reset values. But in a configuration where it is desirable to converge as quickly as possible to a desired RTP, this further implementation gets there faster.

As mentioned in the background section, a “conservative” progressive feature could be designed so that the win limit would never be exceeded, but this would result in small progressive awards particularly in jurisdictions with low maximum win limits, and the progressives would simply reset back to their default reset values after each win. By contrast, aspects of the present disclosure allow for the win limits to be raised to the maximum jurisdictional limit, even for progressives having multiple levels, while guaranteeing that no single progressive award (which can be funded from multiple progressive jackpots) will ever exceed the maximum jurisdictional limit. By raising the reset value to include any excess increment value that accrued over the maximum jurisdictional limit, the player in the immediately following play cycle is that much closer to hitting the strike value in the case of a strike progressive or starts at a higher award value in the case of a target progressive. In addition, in the case of multiple jackpot wins, by optionally funding the progressive award first from the increment value for the jackpot that occurs most rarely ensures getting the award amount to the player as quickly as possible.

In all the examples shown in the figures, the amount in the short-term overflow is applied to adjust the reset value or strike low boundary. Optionally, a representation of the amount of the overflow can be displayed on the electronic video display, akin to an “overflow pot” that can persist in some displayed representation across multiple game cycles to be drawn from as progressive wins are made from time to time. For example, a player may win a relatively small progressive jackpot on a spin in the base game, say in an extreme example only $10, but if there is $900 remaining in the persisting overflow pot, the player could actually be awarded $910 or some amount between $10 and $900 instead of what the player would have otherwise been awarded. The presence of a persisting overflow pot allows progressive win awards in subsequent play cycles to be enhanced by some or all of the amount in the overflow pot. However, the reset values for the jackpots would always be reset to their default values instead of being enhanced. Alternately, some combination of an overflow pot and a smaller enhancement to the reset values can be implemented. In other words, some jackpot overflows can go into a persisting overflow pot, while other portions of those overflows can be used to increase the reset value(s) for one or more jackpots on subsequent play cycles. The representation can include the actual amount or a graphical representation of the amount using size, color, or some other non-quantified indication of the extent of the overflow. Finally, the overflow need not necessarily be applied to adjust the reset value or the strike low boundary. In other aspects, the player can be presented in one or more subsequent play cycles as a mystery award that can be awarded in response to a triggering event occurring in one or more subsequent play cycles of the casino wagering game.

The implementations disclosed herein provide for one common progressive win capping solution. For example, the capping mechanisms disclosed herein provide a solution for any strike progressive, and for any strike or target progressive across all jurisdictions subject to a maximum limit. In the U.S., for example, these implementations ensure that the sum of any base game win plus any progressive win(s) will not exceed the maximum jurisdictional limit. Outside the U.S., for example, these implementations that neither the base game win or the sum of the progressive wins will each not exceed the maximum jurisdictional limit. These implementations can also address variations in, for example, how free spins are handled. For example, in some jurisdictions, one independent win comprising the sum of progressive awards plus the base game win is not allowed to exceed the maximum jurisdictional limit in any given play cycle, and the implementations disclosed herein can be used to ensure compliance with this rule. In other jurisdictions where each free spin in any given play cycle is considered an independent event, no win on any spin will exceed the maximum jurisdictional limit using the implementations disclosed herein. In other words, neither the award in the base game nor the sum of all progressive awards can exceed the maximum jurisdictional limit in any given play cycle. The actual win award is capped or truncated at the maximum jurisdictional limit in the form of a progressive award, but each individual progressive jackpot value can be displayed up to the maximum jurisdictional limit, and the sum of the individual progressive jackpots that are displayed can also exceed the maximum jurisdictional limit. To be clear, the individual jackpot values or the sum of the jackpot values can be displayed up to the maximum jurisdictional limit, but the actual total amount awarded cannot exceed the maximum jurisdictional limit. By allowing the jackpots to be displayed as accruing up to the maximum jurisdictional limit, the present disclosure allows higher jackpot values to be displayed compared to a “conservative” progressive implementation where the amounts neither the jackpot value nor the sum of all jackpot values would be allowed to exceed the maximum jurisdictional limit.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A computer-implemented method of operating a gaming system, the gaming system including a random element generator, game-logic circuitry, and a gaming machine, the gaming machine primarily dedicated to playing at least one casino wagering game, the gaming machine including a cabinet, an electronic display device, and an electronic input device, the cabinet constructed to house components associated with the casino wagering game, the electronic display device and the electronic input device being coupled to the gaming cabinet, the method comprising:
generating one or more random elements with the random element generator;
receiving, responsive to a physical input to the electronic input device of the gaming machine, a wager input to initiate a first play cycle of the casino wagering game;
displaying one or more progressive jackpots on the electronic display device or on another electronic display device of the gaming system;
determining, by the game-logic circuitry, an outcome of the casino wagering game based, at least in part, on the one or more random elements;
displaying the outcome on the electronic display device of the gaming machine;
responsive to a progressive triggering event occurring during the first play cycle, the progressive-triggering event resulting in a win award based on an amount in at least one of the one or more progressive jackpots, awarding, by the game-logic circuitry, no more of the win award than a maximum jurisdictional limit as a progressive award for the first play cycle; and
responsive to the win award exceeding the maximum jurisdictional limit, saving, in an electronic memory device, a difference between the win award and the progressive award such that at least some of the difference is available to fund one or more subsequent play cycles following the first play cycle of the casino wagering game.

2. The method of claim 1, wherein the at least one of the one or more progressive jackpots is a strike progressive, and further comprising:
resetting, by the game-logic circuitry, a strike low boundary for the at least one of the one or more progressive jackpots to be based on at least a reset value for the at least one of the one or more progressive jackpots and the at least some of the difference to produce a new strike low boundary for the at least one of the one or more progressive jackpots.

3. The method of claim 1, wherein the at least one of the one or more progressive jackpots is a strike progressive, and further comprising:
allocating, by the game-logic circuitry, a portion of an amount of the wager input to fund the at least one of the one or more progressive jackpots,
wherein the progressive triggering event includes the portion of the amount being added to the at least one of the one or more progressive jackpots,
thereby causing the win award to exceed the maximum jurisdictional limit.

4. The method of claim 1, wherein the progressive triggering event is a displayed outcome in the casino wagering game, and wherein a portion of the amount of the wager input is added to the at least one of the one or more progressive jackpots.

5. The method of claim 1, wherein the at least one or more progressive jackpots includes a first progressive jackpot and a second progressive jackpot, the first progressive jackpot being associated with a first strike value and a first strike low boundary, the second progressive jackpot being associated with a second strike value and a second strike low boundary, the method further comprising:
calculating, by the game-logic circuitry, a sum that includes the first strike value and the second strike value;
wherein, responsive to the sum exceeding the maximum jurisdictional amount, the progressive award includes (1) the first strike low boundary, (2) the second strike low boundary, and (3) at least some of the remaining first strike value corresponding to a first increment value from the first progressive jackpot, wherein the first strike value has a hit rate that is less than that of the second strike value.

6. The method of claim 5, wherein the difference includes a first difference and a second difference, wherein the first difference is based on at least (1) the first strike value, (2) a first portion of an amount of the wager input, (3) the first strike low boundary, and (4) the first increment value, and the second difference is based on at least (1) the second strike value, (2) a second portion of the amount of the wager input, and (3) the second strike low boundary, the method further comprising:
storing the first difference and the second difference in separate locations in the electronic memory device as a first short-term overflow and a second short-term overflow.

7. The method of claim 6, wherein the first short-term overflow and the second short-term overflow are available to fund the immediately subsequent play cycle following completion of the first play cycle.

8. The method of claim 6, further comprising:
calculating, by the game-logic circuitry, a new first strike low boundary by calculating a first sum that includes (1) the first strike low boundary and (2) the first difference;
setting, by the game-logic circuitry, the first strike low boundary for the first progressive jackpot to be the new first strike low boundary;
calculating, by the game-logic circuitry, a new second strike low boundary by calculating a second sum that includes (1) the second strike low boundary and (2) the second difference; and
setting, by the game-logic circuitry, the second strike low boundary for the second progressive jackpot to be the new second strike low boundary.

9. The method of claim 8, wherein the first strike value represents a minimum amount in the first progressive jackpot that must be funded to award at least part of the first progressive jackpot, wherein the second strike value is not necessarily identical to the first strike value and represents a minimum amount in the second progressive jackpot that must be funded to award at least part of the second progressive jackpot, wherein the first strike low boundary represents a minimum of a range of possible strike values for triggering an award from the first progressive jackpot, and wherein the second strike low boundary represents a minimum of a range of possible strike values for triggering an award from the second progressive jackpot.

10. The method of claim 9, wherein the first strike value is not displayed on the electronic video display as long as the first progressive jackpot is not exceeding the first strike value.

11. The method of claim 1, further comprising raising a reset value for the at least one of the one or more progressive jackpots to include the at least some of the difference.

12. The method of claim 1, further comprising, responsive to the difference exceeding the maximum jurisdictional limit, storing, in the electronic memory device, no more of the difference than the maximum jurisdictional limit as a short-term overflow and storing any excess between the difference and the maximum jurisdictional limit as a long-term overflow, wherein the short-term overflow is available to fund the immediately subsequent play cycle following the first play cycle, and the long-term overflow is available to fund a play cycle following the immediately subsequent play cycle.

13. The method of claim 1, wherein the progressive award is funded first up to a strike low boundary or a reset value associated with the at least one of the one or more progressive jackpots and then, if available, by increment values from the one or more progressive jackpots over the strike low boundary or the reset value up to a strike high boundary or the maximum jurisdictional limit, and wherein the increment values are funded from wager inputs received by the casino wagering game.

14. The method of claim 1, wherein the progressive triggering event is associated with a strike progressive feature or a target progressive feature.

15. The method of claim 1, wherein the win award is based on a portion of the wager input.

16. The method of claim 1, wherein the progressive award is funded first from the at least one of the one or more progressive jackpots having the highest value among all of the one or more progressive jackpots or having the most rare hit rate among all of the one or more progressive jackpots.

17. The method of claim 1, wherein the progressive award is funded first from a reset value for the at least one of the one or more progressive jackpots and then from, if any, increment value remaining in the at least one of the one or more progressive jackpots up to the maximum jurisdictional limit.

18. The method of claim 17, wherein the one or more progressive jackpots includes a first progressive jackpot and a second progressive jackpot, and wherein a hit frequency of the first progressive jackpot is less than a hit frequency of the second progressive jackpot, and wherein the increment value is deducted first from the first progressive jackpot and then, if any, from the second progressive jackpot to fund the progressive award.

19. A gaming system, comprising:
an electronic display device;
an electronic memory device;
a gaming machine primarily dedicated to playing at least one casino wagering game, the gaming machine including a gaming cabinet and an electronic input device, the cabinet constructed to house components associated with the casino wagering game, the electronic input device being coupled to the gaming cabinet and configured to receive a physical input from a player to initiate the casino wagering game and transform the input into an electronic data signal;
a random element generator configured to generate one or more random elements; and
game-logic circuitry configured to:
initiate a first play cycle of the casino wagering game in response to the electronic data signal from the electronic input device of the gaming machine,
display one or more progressive jackpots on the electronic display device;
determine an outcome of the casino wagering game based, at least in part, on the one or more random elements;
direct the electronic display device or another electronic display device to display the outcome; and
in response to a progressive triggering event occurring during the first play cycle, the progressive-triggering event resulting in a win award based on an amount in at least one of the one or more progressive jackpots, award no more of the win award than a maximum jurisdictional limit as a progressive award for the first play cycle; and
in response to the win award exceeding the maximum jurisdictional limit, save, in the electronic memory device, a difference between the win award and the progressive award such that at least some of the difference is available to fund one or more subsequent play cycles following the first play cycle of the casino wagering game.

20. The gaming system of claim 19, wherein:
the progressive award is funded first from a reset value for the at least one of the one or more progressive jackpots and then from, if any, increment value remaining in the at least one of the one or more progressive jackpots up to the maximum jurisdictional limit,
the one or more progressive jackpots includes a first progressive jackpot and a second progressive jackpot,
a hit frequency of the first progressive jackpot is less than a hit frequency of the second progressive jackpot, and
the increment value is deducted first from the first progressive jackpot.
